(19) United States
(12) Patent Application Publication
(10) Pub. No.: US 2017/0235716 A1
(43) Pub. Date: Aug. 17, 2017

(54) CONTEXT DRIVEN ARTIFACT SERVICE MANAGEMENT

(71) Applicant: International Business Machines Corporation, Armonk, NY (US)

(72) Inventors: Kristin M. Arrowood, Raleigh, NC (US); Clyde T. Foster, Raleigh, NC (US); Joseph N. Kozhaya, Morrisville, NC (US); Douglas A. Williams, Durham, NC (US)

(21) Appl. No.: 15/042,562

(22) Filed: Feb. 12, 2016

(51) Int. Cl. G06F 17/27; H04L 12/26; H04L 29/08; G06F 17/22

(52) U.S. Cl. CPC G06F 17/277; G06F 17/2288; H04L 43/10; H04L 67/306; H04L 67/06; H04L 67/142; H04L 67/32

(57) ABSTRACT

Embodiments include method, systems and computer program products for dynamic national language support. In some embodiments, a request may be received from a client. An operation associated with the request may be determined. Context information may be extracted from the request. An artifact service instance may be selected based on the operation and the context information. Transmission of processed content from the artifact service instance may be facilitated in response to the request from the client.

### BACKGROUND

The present disclosure relates to data processing, and more specifically, to methods, systems and computer program products for context driven artifact service management.

Applications developed for international distribution need to support different languages and are known as National Language Support (NLS) (also known as software internationalization and localization). NLS is a means for adapting applications to different languages, regional differences, and technical requirements of a target market. Specifically, localization is the process of adapting internationalized applications for a specific region or language by adding locale-specific components and translating text. NLS may require the developers to embed NLS as part of their application. Common techniques to do so include using ResourceBundles or XML. There are different tradeoffs between the different techniques but all of them require application developers to handle NLS at the application level, which requires significant development effort.

### SUMMARY

In accordance with an embodiment, a method for context driven artifact service management is provided. The method may include receiving a request from a client; determining, by a processor, an operation associated with the request; extracting context information from the request; selecting an artifact service instance based on the operation and the context information; and facilitating transmission of processed content from the artifact service instance in response to the request from the client.

In another embodiment, a computer program product may comprise a non-transitory storage medium readable by a processing circuit and storing instructions for execution by the processing circuit for performing a method that may include receiving a request from a client; determining an operation associated with the request; extracting context information from request; selecting an artifact service instance based on the operation and the context information; and facilitating transmission of processed content from the artifact service instance in response to the request from the client.

In another embodiment, a system may include a processor in communication with one or more types of memory. The processor may be configured to receive a request from a client; determine an operation associated with the request; extract context information from the request; select an artifact service instance based on the operation and the context information; and facilitate transmission of processed content from the artifact service instance in response to the request from the client.

### BRIEF DESCRIPTION OF THE DRAWINGS

The forgoing and other features, and advantages of the disclosure are apparent from the following detailed description taken in conjunction with the accompanying drawings in which:

FIG. 1 is a block diagram illustrating one example of a processing system for practice of the teachings herein;

FIG. 2 is a block diagram illustrating a computing system in accordance with an exemplary embodiment;

FIG. 3 is a flow diagram of a method for obtaining a client token for use in a dynamic national support environment in accordance with an exemplary embodiment; and

FIG. 4 is a flow diagram of a method for a dynamic national support environment in accordance with an exemplary embodiment.

### DETAILED DESCRIPTION

In accordance with exemplary embodiments of the disclosure, methods, systems and computer program products for context driven artifact service management are provided. The methods and systems described herein are directed to software application to dynamically determine language and locale for a user, communicate request to an National Language Support (NLS) service provider using a representational state interface (ReST), and update NLS relevant components in the application dynamically (e.g., user interface of the software application). The systems and methods may also be directed to how an NLS service provider identifies which NLS instance to query and provide content back to the application.

In some embodiments, the systems and methods described herein may provide a document management system that horizontally scales for a large number of client, where client may include consumer cloud resident micro services or end user application interfaces, which need to access documents with included language translation support. Such a system may be utilized for the overall management of meta data or any documents that are to be translated or transformed into native formats meeting the needs of document consumers that participate in public or private cloud or cloud hybrid environments. Furthermore, a user's role preference context may be utilized to provide customized options and access controls for the user in their given role.

In some embodiments, the dynamic NLS environment may include multiple components. For example, the dynamic NLS environment may an NLS service provider and a client application. The NLS service provider may offer NLS service through a ReST interface. NLS service instances may register with a Provider Registry to indicate what languages and locales they support. In some embodiments, the NLS service provider may leverage monitoring agents to track usage of different NLS service instances. In some embodiments, the NLS service provider may add or reconfigure NLS instances based on demand and usage.

In one example embodiment, the NLS service provider may initialize four NLS service instances (e.g., two for English language and two for French language). The monitoring agents may report a higher demand for English service. The NLS service provider may reconfigure the instances to have three NLS service instances for English and one for French.

In some embodiments, the NLS service provider may perform intelligent caching based on a specific language of clients accessing it.

In some embodiments, the client application may send a request to NLS service proxy for a particular item, such as files associated with a label or a particular electronic file. The application may specify which language and locale are needed for the item. In some embodiments, the application may check a user profile and pass the language or locale information associated with the user's profile to the NLS service proxy. In some embodiments, the use profile may be associated with multiple languages and/or locales. A user may desire to see items in multiple languages (e.g., English and French).

In some embodiments, the application may identify the geography of where a request originated (e.g., mobile devices may be identified using geolocation services; client IP address associated with the client device may also indicate similar information). For example, an application executing on a device in France may request the item be in French.

In some embodiments, the NLS service proxy may check a provider registry to determine which NLS service instance it needs to query for the specified label. In some embodiments, intelligent caching mechanisms may optimize response times. IN some embodiments, the application may update a user interface with information associated with the item in the desired language or locale. Some user interfaces may display the item in multiple languages. For example, an English-speaking user may his profile for English. The user may travel to France, where the user interface may display the item in both English (primary language preference) and French (secondary language preference).

In some embodiments, the application may prompt the user to update their profile with newly identified languages of interest (e.g., if the user frequently travels to France, the user may be interested in viewing the requested item in both English and French.)

Although the description herein is described in the context of a client application, the systems and methods described herein may be applied more broadly to any type of application as well as service provider contributing some component to the application that requires NLS (e.g., user interfaces).

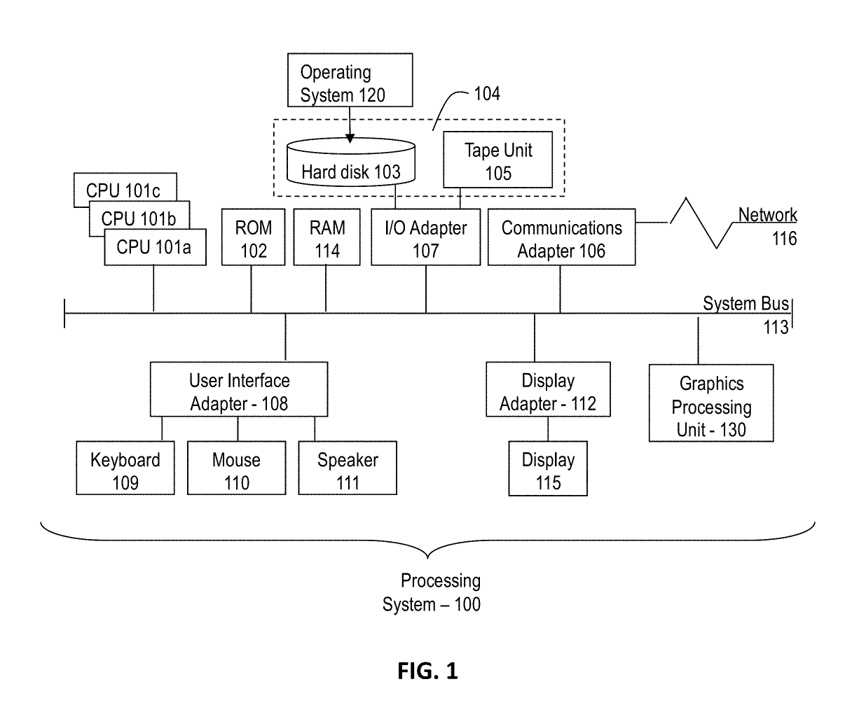

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adapter 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics-processing unit 130. Graphics processing unit 130 is a specialized electronic circuit designed to manipulate and alter memory to accelerate the creation of images in a frame buffer intended for output to a display. In general, graphics-processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

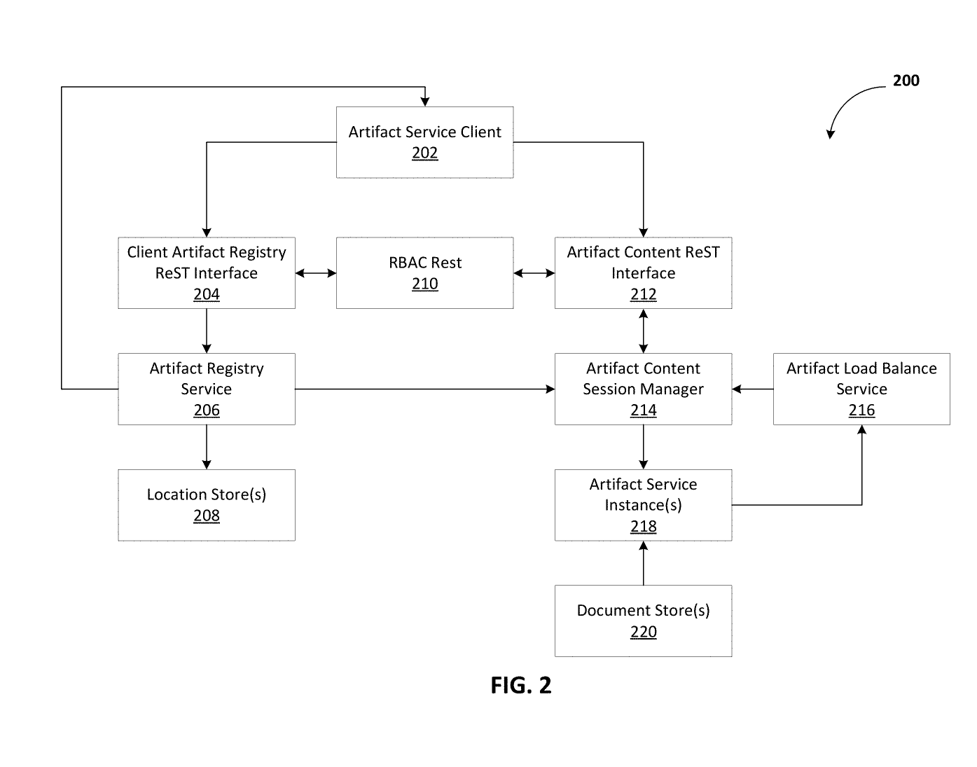

Referring now to FIG. 2, a computing system 200 in accordance with an embodiment is illustrated. As illustrated, the computing system 200 may include, but is not limited to, an Artifact Service Client 202, an Client Artifact Registry ReST Interface 204, an Artifact Registry Service 206, one or more Location Store(s) 208, a Role-Based Access Control REST (RBAC REST) 210, an Artifact Content ReST Interface 212, an Artifact Content Session Manager 214, one or more Artifact Service Instance(s) 218, one or more Document Store(s) 220, and an Artifact Load Balance Service 216.

In some embodiments, the Artifact Service Client 202 may reside on any type of user device, which may include smartphones, tablets, laptops, desktop, server, and the like. In some embodiments, the Client Artifact Registry ReST Interface 204, the Artifact Registry Service 206 may reside on a single device or may be on separate devices. The RBAC REST 210 may be a third-party entity. In some embodiments, the Artifact Content ReST Interface 212, the Artifact Content Session Manager 214, and the Artifact Load Balance Service 216 may reside on a single device or may be distributed among multiple devices. In some embodiments, the one or more Artifact Service Instance(s) 218 and/or database cluster (e.g., which may include one or more Document Store(s) 220) may be on a single device or on multiple devices.

FIG. 2 is an example embodiment for dynamic NLS, which shows an artifact client consumer that may represent a micro service or an end user client application interface utilizing a document model and dynamic NLS management system in a cloud-computing environment. The interfaces (e.g., Client Artifact Registry ReST Interface 204) may be RESTFUL, providing full abstract loose coupling separation between the client entity (e.g., Artifact Service Client 202) and the document service it uses.

In an example data flow, the Artifact Service Client 202 may transmit a request for one or more tokens to access and utilize a dynamic NLS system. The request may be transmitted to a Client Artifact Registry ReST Interface 204, which may interact with a role-based access control REST (RBAC REST) 210 to determine whether the user is entitled to access REST services. If the user is entitled, the request may be transmitted to an Artifact Registry Service 206. The Artifact Registry Service 206 may obtain data from one or more Location Store(s) 208 based on the data in the request. The Artifact Registry Service 206 may transmit a portion of the data (e.g., references to the profiles associated with the user and their associated roles) received from the one or more Location Store(s) 208 to an Artifact Content Session Manger 214 to obtain a session token and additional information related to the user-role concerning the preferences for the user-role. The Artifact Registry Service 206 may generate a response to the request initiated by the Artifact Service Client 202 that includes the session token, the user-role token, and user-role profile information, which the Artifact Service Client 202 may use to utilize the services of the dynamic NLS system.

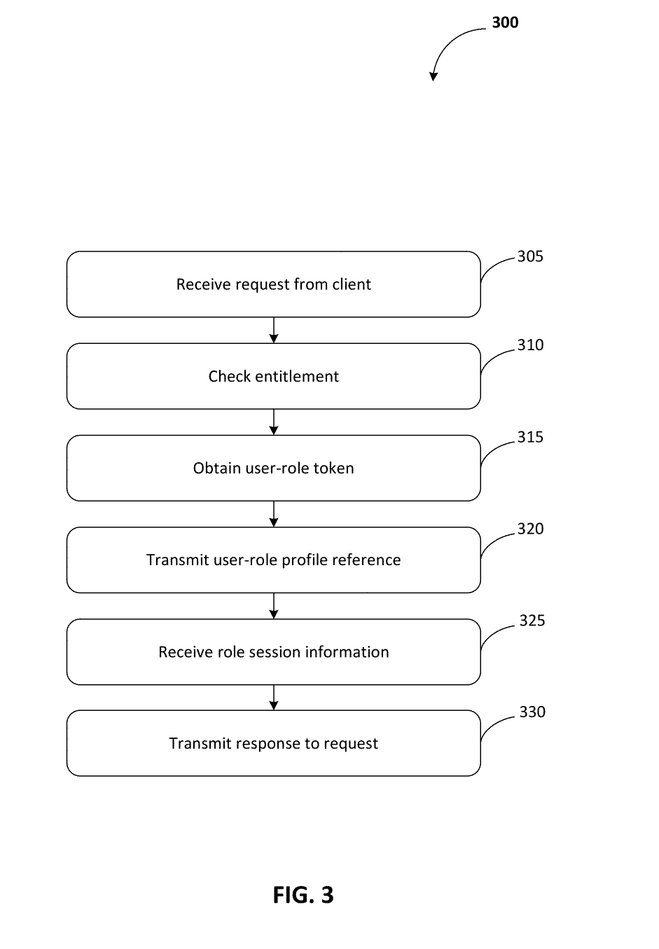

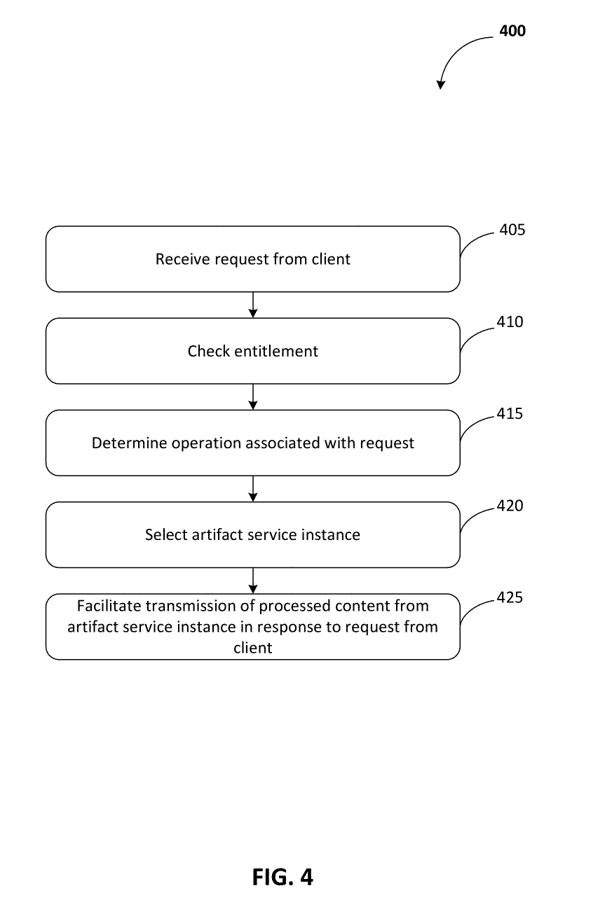

In some embodiments, the Artifact Service Client 202 may transmit a request for an item (e.g., electronic documents). The Artifact Content ReST Interface 212 may receive the request from the Artifact Service Client 202 and may communicate with the RBAC REST 210 to determine whether the user associated with the request is entitled to REST service. If the user is entitled, the request may be transmitted to an Artifact Content Session Manager 214, which may analyze the request to determine an operation associated with the request and to select an artifact service instance 218 to fulfill the request. In some embodiments, the selected Artifact Service Instance 218 may obtain the requested item from a database cluster, which may include a Document Store 220 and may perform the requested operation based on the request. In some embodiments, the Artifact Load Balance Service 216 may monitor the resource utilization of a group of Artifact Service Instances 218 and may perform load-balancing optimizations to ensure requests received from Artifact Service Clients 202 are efficiently fulfilled. Further details of the dynamic NLS are discussed in FIGS. 3-4 below.

Now referring to FIG. 3, a flow diagram of a method 300 for obtaining a client token for use in a dynamic national support environment in accordance with an exemplary embodiment is provided.

At block 305, the Client Artifact Registry ReST Interface 204 may receive a request from a client, such as the Artifact Service Client 202. In some embodiments, the request may be a token request. In some embodiments, a user may issue a request through the Artifact Service Client 202. In some embodiments, the request may be an HTTP/HTTPS RESTFUL GET that returns a client token used subsequently to further access document assets and features needed by client (e.g., Artifact Service Client 202) on behalf of a particular role associated with the user (e.g., user context).

At block 310, the Client Artifact Registry ReST Interface 204 may check the entitlement associated with the request. When the GET request for returning the client role token information is interrogated at the REST service responsible for locating the profile information, the entitlement to use the REST interface is checked by accessing the native role-based access control (RBAC) service 210 using information provided by the client.

The RBAC Service 210 may return true or false for the checked authorization of the user context with respect to the REST service entitlement. If the authorization fails, a notification is transmitted to the Artifact Service Client 202 that the authorization failed. If the authorization is accepted, then the Artifact Registry Service 206 may receive the REST GET information, which comprises the user context and the user's role, which may then be used to locate a profile representing the user's role. The profile may be used to later decide document entitlements and specific processing relevant to the user's profile information. As an example, if the user is French the user profile may indicate a transaction preference. The role of the user may determine entitlements to documents for the user's role based on permissions for the user's role.

At block 315, the Artifact Registry Service 206 may obtain a user-role token. The Artifact Registry Service 206 may access a Location Store 208, which may contain references to the profiles associated with particular users and associated roles, which may be used to retrieve a user role token that subsequent requests may use to identify customization and entitlements for a particular user role in use by the consumer client. The registry store may be clustered to assure availability of the service in the cloud-computing environment.

At block 320, the Artifact Registry Service 206 may transmit the user-role profile reference to an Artifact Content Session Manager 214. Once a user-role profile reference is identified, it is provided as an internal request to the Artifact Content Session Manager 214 to retrieve a session token and additional information, which may be related to the user-role (e.g., preferences for the user-role that can be later modified by the user if necessary).

At block 325, the Artifact Registry Service 206 may receive role session information from the Artifact Content Session Manager 214. The role session information may be returned to the Artifact Registry Service 206, which may then generate a response to the original request. The response may include the role session information in the payload of the response.

At block 330, the Artifact Registry Service 206 may transmit the response to the Artifact Service Client 202 in response to the received request. The Artifact Registry Service 206 may generate a response containing the user-role profile information, the user-role token, and the session token and may transmit the response to the Artifact Service Client 202.

Now referring to FIG. 4, a flow diagram of a method 400 for a dynamic national support environment in accordance with an exemplary embodiment is provided.

At block 405, the Artifact Content ReST Interface 212 may receive a request from the Artifact Service Client 202. In some embodiments, the Artifact Service Client 202 may transmit a REST GET/POST/PUT/DELETE request to the Artifact Content ReST Interface 212. The request may be initiated by the client consumer providing at least the user context, the user-role token, and the session token earlier returned by the registry service REST request. (e.g., as described in FIG. 3).

At block 410, the Artifact Content ReST Interface 212 may check the entitlement associated with the request. The Artifact Content ReST Interface 212 may check the entitlement for the user context to use the REST service by checking whether the user context is authorized to use the REST service. The RBAC Service 210 may be contacted to determine whether or not the REST service can be used by the request. If the user context is not authorized to use the Artifact Content ReST Interface 212, then the request may be returned with a not authorized error. If the user context is authorized to use the Artifact Content ReST Interface 212, the request may be transmitted to the Artifact Content Session Manager 214, which may then determine whether the request has a valid session and user-role token. If the session token is invalid, the request may be returned in error indicating the invalid token.

At block 415, the Artifact Content Session Manager 214 may determine an operation associated with the request. The Artifact Content Session Manager 214 may analyze the request to determine the desired operation. Operations may include retrieving items (e.g., electronic documents) and possibly translating or transforming them, placing items into a repository or updating and deleting specific items. Once the operation is determined, the RBAC service 210 may be contacted to retrieve entitlements for the operation and the operation item targets by checking the user-role permissions in the RBAC repository.

In some embodiments, the Artifact Content Session Manager 214 may extract context information from the request. Context information may be indicative of a setting, circumstance, or environment that may compel the processing (e.g., translation, etc.) of items.

At block 420, the Artifact Content Session Manager 214 may select an Artifact Service Instance 218. Assuming the request can be satisfied after authorization has occurred, the Artifact Content Session Manager 214 may bind the request an Artifact Service Instance 218 from a group of Artifact Service Instances 218 to satisfy the request. There may be multiple instances of the Artifact Service Instances 218 across a clustered cloud enabled environment to assure high availability and horizontal scale for satisfying client requests. In some embodiments, the Artifact Content Session Manager 214 may select an Artifact Service Instance 218 based on the operation determined at block 415 and/or context information extracted from the request received from the Artifact Service Client 202.

All cluster configured Artifact Service Instances 218 may access a database cluster, such as a document store 220, (which may itself be distributed across cores, machines, or containers) that contains the actual document contents. Once content is retrieved, the Artifact Service Instance 218 may perform the requested operation (e.g., translation, transformation, or other updates based on the user-role preferences and requested operation applicable to the request).

To maintain proper balancing of both the Artifact Service Instances 218 and the database cluster accessed by these instances, monitoring agents may be used to keep track of utilization and traffic statistics occurring for the Artifact Service Instances 218 and the transactions occurring for them involving the database cluster. In some embodiments, the monitoring agents may execute on a separate device and may monitor each artifact service instance 218 remotely. In some embodiments, each Artifact Service Instance 218 may execute a monitoring agent, which may transmit data collected for the Artifact Service Instance 218 to an Artifact Load Balance Service 216. The Artifact Load Balance Service 216 may analyze the data obtained from the one or more monitoring agents and may transmit recommendations or other data to the Artifact Content Session Manager 214. The Artifact Content Session Manager 214 may use the information provided by the Artifact Load Balance Service 216 to select an Artifact Service Instance 218 to fulfill a received request.

Information from the monitoring agents may be used by an Artifact Load Balancing Service 216 to determine changes to the overall provisioning and partitioning of the Artifact Service Instances 218 and the database cluster they use.

At block 425, the Artifact Content Session Manager 214 may facilitate transmission of processed content from the Artifact Service Instance 218 in response to the request from the client (e.g., Artifact Service Client 202). The Artifact Content Session Manager 214 may transmit the processed content received from the Artifact Service Instance 218 to the requesting Artifact Service Client 202.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for artifact service management comprising:
receiving a request from a client;
determining, by a processor, an operation associated with the request;
extracting context information from the request;
selecting an artifact service instance based on the operation and the context information; and
facilitating transmission of processed content from the artifact service instance in response to the request from the client.

2. The computer-implemented method of claim 1, further comprising:
determining entitlement associated with a user associated with the request.

3. The computer-implemented method of claim 1, wherein the artifact service instance is associated with a monitoring agent that monitors resource utilization by the artifact service instance, traffic statistics associated with the artifact service instance, or transactions associated with the artifact service instance at a database cluster.

4. The computer-implemented method of claim 1, wherein selecting the artifact service instance further comprises:
receiving data from an artifact load balance service, wherein the data is generated obtained from a plurality of monitoring agents corresponding to a respective artifact service instance of a plurality of artifact service instances.

5. The computer-implemented method of claim 1, wherein an operation is one of retrieving an electronic file, deleting the electronic file, transforming the electronic file, transmitting the electronic file to a repository, or updating an electronic file.

6. The computer-implemented method of claim 1, further comprising:
receiving a token request from the client;
obtaining a user-role token;
transmitting a user-role profile to an artifact content session manager;
receiving a session token; and
transmitting a response to the client comprising the user-role token, the session token, and the user-role profile.

7. The computer-implemented method of claim 6, further comprising:
obtaining the user-role profile from a location store.

8. The computer-implemented method of claim 1, further comprising:
selecting the artifact service instance based on the context information.

9. A computer program product comprising a non-transitory storage medium readable by a processing circuit and storing instructions for execution by the processing circuit for performing a method comprising:
receiving a request from a client;
determining an operation associated with the request;
extracting context information from the request;
selecting an artifact service instance based on the operation and the context information; and
facilitating transmission of processed content from the artifact service instance in response to the request from the client.

10. The computer program product of claim 9, wherein the method further comprises:
determining entitlement associated with a user associated with the request.

11. The computer program product of claim 9, wherein the artifact service instance is associated with a monitoring agent that monitors resource utilization by the artifact service instance, traffic statistics associated with the artifact service instance, or transactions associated with the artifact service instance at a database cluster.

12. The computer program product of claim 9, wherein selecting the artifact service instance further comprises:
receiving data from an artifact load balance service, wherein the data is generated obtained from a plurality of monitoring agents corresponding to a respective artifact service instance of a plurality of artifact service instances.

13. The computer program product of claim 9, wherein an operation is one of retrieving an electronic file, deleting the electronic file, transforming the electronic file, transmitting the electronic file to a repository, or updating an electronic file.

14. The computer program product of claim 9, wherein the method further comprises:
receiving a token request from the client;
obtaining a user-role token;
transmitting a user-role profile to an artifact content session manager;
receiving a session token; and
transmitting a response to the client comprising the user-role token, the session token, and the user-role profile.

15. The computer program product of claim 14, wherein the method further comprises:
obtaining the user-role profile from a location store.

16. A system, comprising:
a processor in communication with one or more types of memory, the processor configured to:
receive a request from a client;
determine an operation associated with the request;
extract context information from the request;
select an artifact service instance based on the operation and the context information; and
facilitate transmission of processed content from the artifact service instance in response to the request from the client.

17. The system of claim 16, wherein the processor is further configured to:
determine entitlement associated with a user associated with the request.

18. The system of claim 16, wherein the artifact service instance is associated with a monitoring agent that monitors resource utilization by the artifact service instance, traffic statistics associated with the artifact service instance, or transactions associated with the artifact service instance at a database cluster.

19. The system of claim 16, wherein, to select the artifact service instance, the processor is further configured to:
receive data from an artifact load balance service, wherein the data is generated obtained from a plurality of monitoring agents corresponding to a respective artifact service instance of a plurality of artifact service instances.

20. The system of claim 16, wherein an operation is one of retrieving an electronic file, deleting the electronic file, transforming the electronic file, transmitting the electronic file to a repository, or updating an electronic file.
